(19) United States
(12) Patent Application Publication
(10) Pub. No.: US 2016/0138640 A1
(43) Pub. Date: May 19, 2016

(54) FASTENER

(71) Applicant: ESSENCE METHOD REFINE CO., LTD., TAINAN CITY (TW)

(72) Inventor: LING-FANG CHEN, TAINAN CITY (TW)

(21) Appl. No.: 14/540,246

(22) Filed: Nov. 13, 2014

(51) Int. Cl. F16B 35/04

(52) U.S. Cl. CPC F16B 35/041

(57) ABSTRACT

A fastener comprises a shank defining a shank root, a head, a drilling portion and main threads. Each of the main threads is inclined with respect to a shank axis by 60-82 degrees. At least one main lobe projects from the shank. The main lobe is extended outwards from the shank root and attached to at least one cutting face of each main thread. Accordingly, the inclining arrangement allows the main threads to have a large rotating angle at the time of drilling and increase the drilling speed. By the main lobe in connection with the main thread, the fastener attains the preferable torque and flexibility, enhances the torsion resistance and the tensile strength against the drilling stress to prevent the fastener from snapping and reduces the resonant vibratory effect caused by vibrations after the drilling action, thereby promoting a firm fastening effect.

### BACKGROUND OF THE INVENTION

1. Field of the Invention

This invention relates to a fastener and relates particularly to a fastener with a good fastening effect and better mechanical characteristics, such as the torsion resistance and the tensile strength.

2. Description of the Related Art

Referring to FIG. 1, a conventional screw 1 comprises a shank 11, a head 12 disposed on one end of the shank 1 and a plurality of threads 13 spirally disposed on the shank 11. To increase the drilling speed, the thickness of the thread 13 is reduced to sharpen the thread 13. In use, a rotary force is imparted to the head 12 to drill the threads 13 into an object 2 and screw the screw 1 to the object 2.

The screw 1 has some problems in the use. For example, the threads 13 are rapidly rolled and formed on the shank 11 by using thread rolling plates (not shown). Generally, thread rolling plates need some teeth to engage an outer wall of the shank 11 so that the threads 13 can be formed on the shank 11 successfully. The outer wall of the shank 11, however, becomes uneven when the threads 13 are rolled on the shank 11. The screw 1 has the poor flexibility and torsion because of this uneven portion of the shank 11 and this even portion snaps easily under the drilling stress. Therefore, the fastening effect of the screw 1 is reduced. Even though the screw 1 is fastened to the object 2 successfully, the screw 1 may snap inside the object 2 automatically under the stress due to the fact that the screw 1 is over twisted and becomes deformed.

The threads 13 with a small thickness facilitate a sharp cutting effect to increase the drilling speed. However, the high temperature of the thermal treatment for processing threads renders the thin threads 13 a higher superficial temperature and causes the threads 13 to split and break easily under a slight pressure of the drilling action. Thus, the drilling speed becomes slow, not fast. In contrast, the threads 13 with a large thickness may prevent the screw 1 from breaking easily, but the threads 13 becomes more and more passivated after a long term of use. This also slows the drilling speed down. Therefore, the conventional screw 1 still needs to be improved.

### SUMMARY OF THE INVENTION

The object of this invention is to provide a fastener preventing the shank from snapping and preventing the resonant vibratory effect after the fastener is screwed into the object, thereby attaining the firm fastening effect.

Accordingly, the fastener in accordance with this invention comprises a shank defining a shank root, a head and a drilling portion disposed at two ends of the shank and a plurality of main threads spirally disposed on the shank. Each of the main threads comprises two inclined cutting faces connected with each other. Each main thread is inclined with respect to a shank axis by 60-82 degrees. At least one main lobe is extended outwards from the shank root and attached to at least one cutting face of each main thread. Accordingly, the inclining angle allows the main threads to have a large rotating angle at the time of drilling, thereby increasing the drilling speed. By the main lobe in cooperation with the main threads and the shank, the fastener attains the preferable torque and flexibility, enhances the torsion resistance and the tensile strength against the drilling stress to prevent the fastener from snapping, and decreases the resonant vibratory effect caused by external vibrations to promote a firm fastening effect.

Preferably, the main lobe is formed in a curved shape.

Preferably, at least one auxiliary thread is disposed between any two adjacent main threads. A diameter of the auxiliary thread is smaller than a diameter of each main thread.

Preferably, the auxiliary thread comprises two auxiliary cutting faces connected with each other. At least one support lobe projects from the shank, with the support lobe extended outwards from the shank root and attached to at least one auxiliary cutting face of the auxiliary thread.

Preferably, the shank has a plurality of slits recessedly defined thereon, with each of the slits extending between two adjacent main threads. Each of the slits is intersected with the shank root of the shank to form a cutting edge.

Preferably, the drilling porting has a helical section coming to a sharp leading point.

Preferably, each of the main threads comprises a plurality of notches formed thereon.

The advantages of this invention are more apparent to those skilled in the art upon reading following descriptions in conjunction with accompanying drawings.

### BRIEF DESCRIPTION OF THE DRAWINGS

FIG. 1 is a schematic view showing a conventional screw;

FIG. 2 is a schematic view showing a first preferred embodiment of this invention;

FIG. 3 is a cross-sectional view showing the first preferred embodiment of this invention;

FIG. 4 is a schematic view showing a second preferred embodiment of this invention;

FIG. 5 is a cross-sectional view showing the second preferred embodiment of this invention;

FIG. 6 is a schematic view showing a third preferred embodiment of this invention;

FIG. 7 is a cross-sectional view showing the third preferred embodiment of this invention;

FIG. 8A and FIG. 8B are schematic views showing the variations of the drilling portion of this invention;

FIG. 9 is a schematic view showing the drilling portion of this invention in a sharply-pointed structure;

FIG. 10 is a schematic view showing a fourth preferred embodiment of this invention;

FIG. 11 is a cross-sectional view showing the fourth preferred embodiment of this invention;

FIG. 12 is a schematic view showing a fifth preferred embodiment of this invention;

FIG. 13 is a cross-sectional view showing the fifth preferred embodiment of this invention;

FIG. 14 is a schematic view showing a sixth preferred embodiment of this invention;

FIG. 15 is a cross-sectional view showing the sixth preferred embodiment of this invention;

FIG. 16 is a schematic view showing a seventh preferred embodiment of this invention;

FIG. 17 is a cross-sectional view showing the seventh preferred embodiment of this invention;

FIG. 18 is a schematic view showing an eighth preferred embodiment of this invention in one variation;

FIG. 19 is a cross-sectional view showing the A-A part of FIG. 18;

FIG. 20 is a schematic view showing the eighth preferred embodiment of this invention in another variation;

FIG. 21 is a schematic view showing a ninth preferred embodiment of this invention;

FIG. 22 is a schematic view showing a tenth preferred embodiment of this invention;

FIG. 23 is a schematic view showing an eleventh preferred embodiment of this invention; and

FIG. 24 is a schematic view showing a twelfth preferred embodiment of this invention.

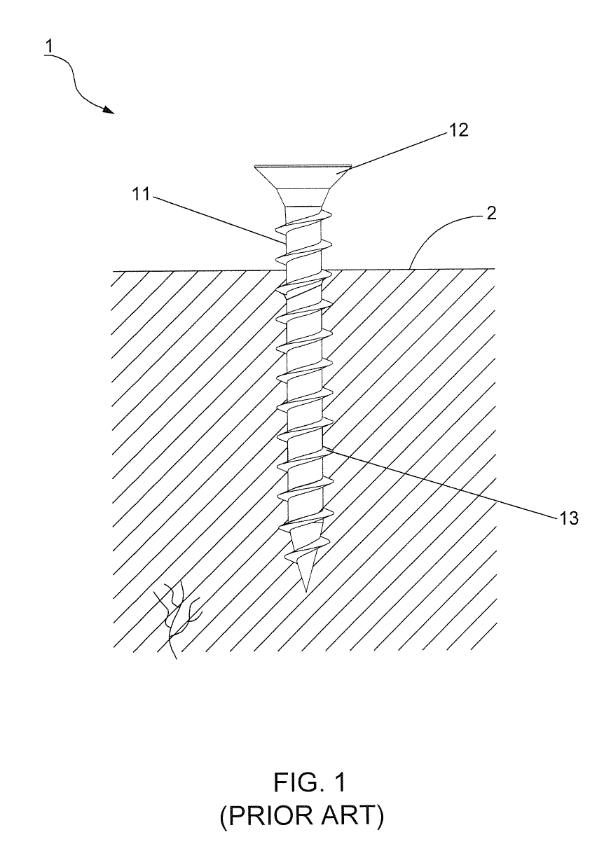

### DETAILED DESCRIPTION OF THE PREFERRED EMBODIMENTS

A fastener 3 of this invention is applied to various materials, such as plastic materials, light metal alloy materials and materials with fibers. Herein, only the material with fibers is adopted as an example.

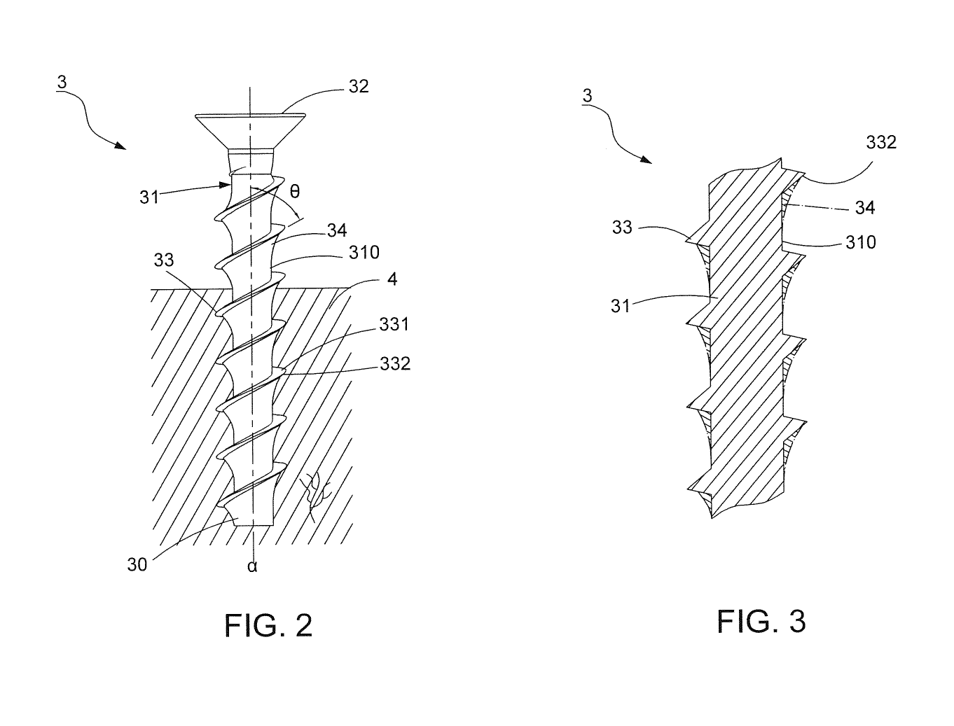

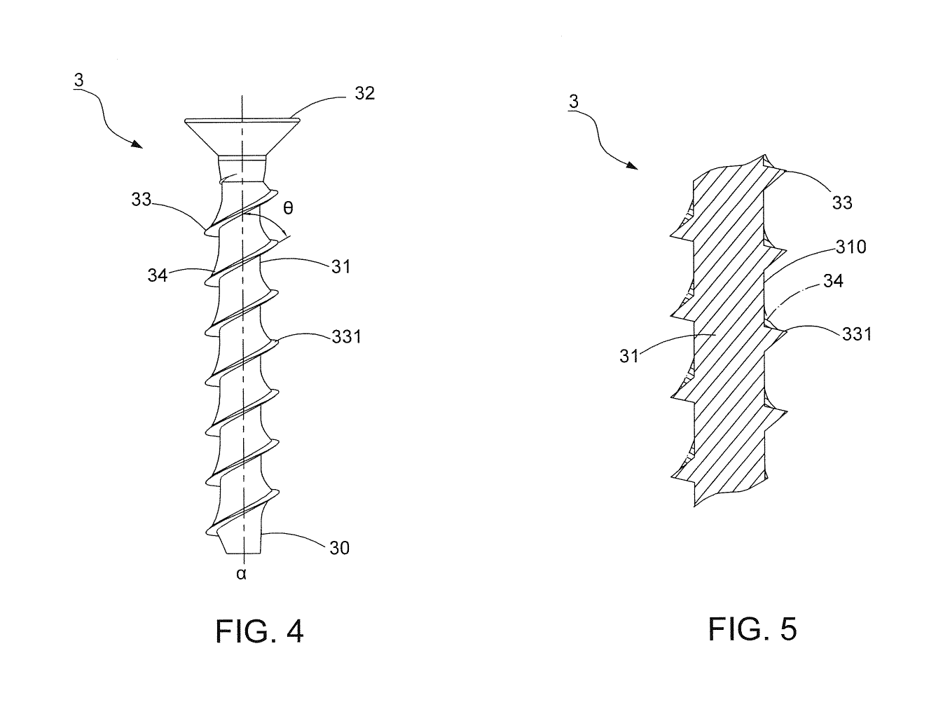

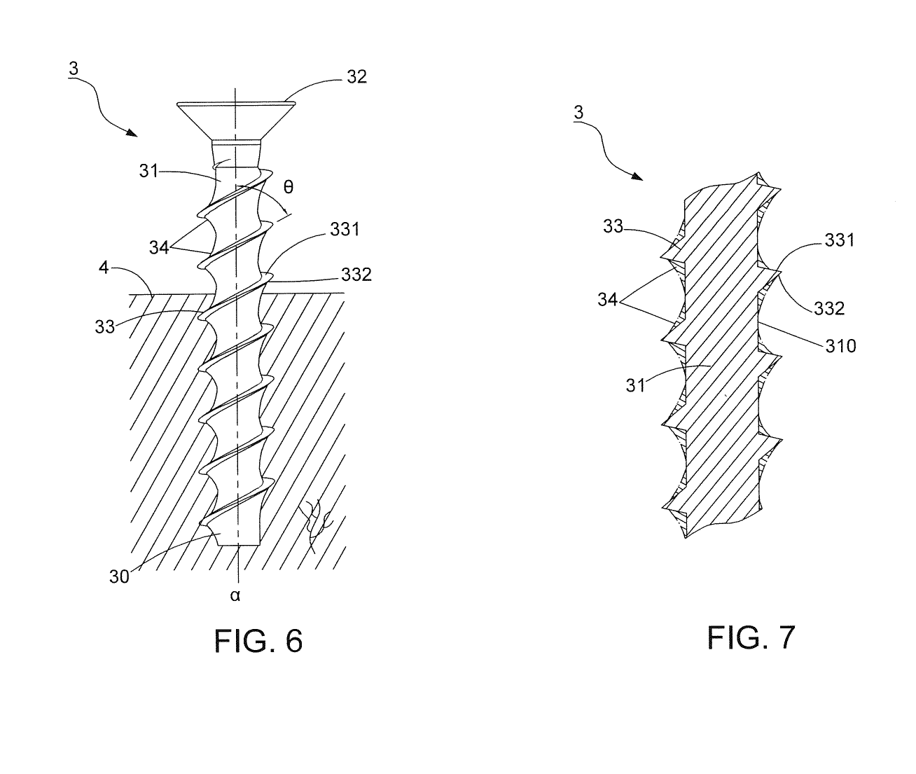

Referring to FIGS. 2-3, a first preferred embodiment of this invention comprises a shank 31 defining a shank root 310, a head 32 disposed at one end of the shank 31, a drilling portion 30 disposed on the other end of the shank 31, and a plurality of main threads 33 spirally disposed on the shank 31. Each of the main threads 33 comprises two inclined cutting faces 331, 332 connected with each other. Each of the main threads 33 is inclined with respect to a shank axis α by an angle θ, preferably between 60 degrees and 82 degrees. The configuration of the main thread 33 can be adjusted according to the hardness of an object 4. In other words, the thickness and the height of the main thread 33 can be added or lessened to promote the cutting and drilling effect. At least one main lobe 34 is designed to project from the shank 31. More precisely, the main lobe 34 is extended outwards from the shank root 310 and attached to at least one cutting face of each main thread 33. The main lobe 34 can be formed in a curved shape. For example, FIGS. 2-3 show the curved main lobe 34 spreads upwards from the shank root 310 to the lower cutting face 332 to support the main thread 33. FIGS. 4-5 show the curved main lobe 34 spreads downwards from the shank root 310 to the upper cutting face 331 of the main thread 33, and the upper cutting face 331 with no main lobe 34 can be a smooth face or an angular face to impart a downward pressure to the fastener 3 and prevent the fastener 3 from loosening from the object 4. The fastener 3 attains the high force to resist vibrations after the drilling operation, thereby increasing the tensile strength. FIGS. 6-7 show curved main lobes 34 spread from the shank root 310 to the cutting faces 331,332 concurrently. The design shown in FIGS. 6-7 is mainly presented in following descriptions.

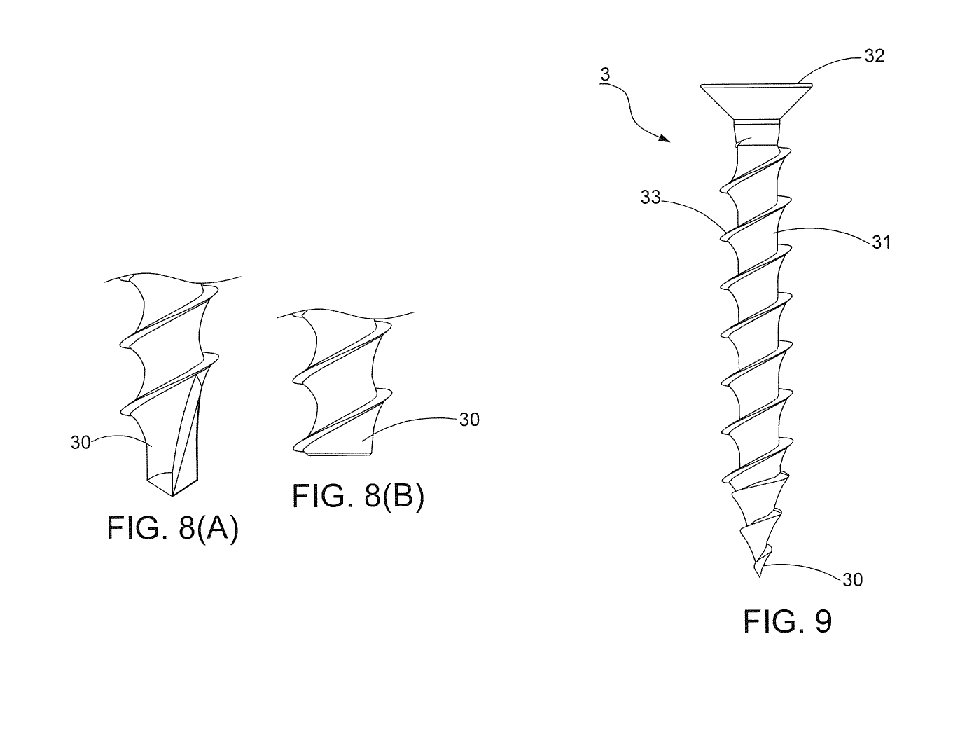

Furthermore, the drilling portion 30 can include, but not limited to, a narrow end surface as shown in FIG. 2, a drill tip with grooves as shown in FIG. 8A, a flat end surface as shown in FIG. 8B and/or a helical section coming to a sharp leading point as shown in FIG. 9. The drilling portion 30 with the sharp leading point is formed by rolling so that the rolled part becomes denser and stronger. Accordingly, the drilling portion 30 can drill the sharp leading point into the object 4 by hammering or screwing rotably.

The operation of the fastener 3 is explained with the aid of FIGS. 6-7. The head 32 is rotated by a rotation force to drive the main threads 33, and an object 4 is cut by the driven main threads 33. Therefore, the fastener 3 enters the object 4 quickly. During the drilling operation, the inclined angle θ of each main thread 33 ranging from 60-82 degrees creates a bigger rotating angle when the main threads 33 rotate and drill into the object 4. Such a bigger rotating angle increases the drilling speed. Further, the extension of the main lobe 34 from the shank root 310 to the cutting faces 341, 342 supports the main threads 33 to facilitate a rapid drilling action and bear the increasing drilling stress impinging on the drilling operation. The main lobes 34 formed in a curved slope also prevent the shank 31 from twisting and snapping and prevent the main threads 33 from breaking or cracking at the time of drilling. Therefore, the drilling speed is largely promoted. The fiber debris surrounding the main threads 33 is moved along the periphery of each main lobe 34 so that the debris can be withdrawn from the object 4, and the residual debris surrounding the shank 31 stays at the center of the main lobe 34. Therefore, the resonant vibratory effect caused by external forces after the fastener 3 is screwed into the object 4 is prevented, whereby the smoothness of the drilling operation is increased and the fastener 3 is firmly screwed into the object 4.

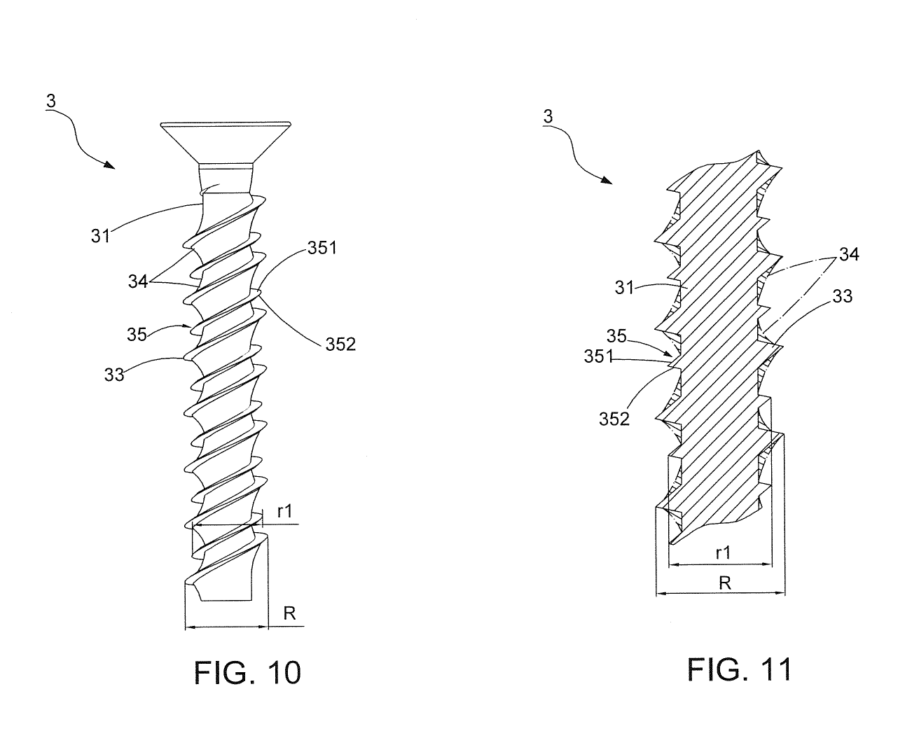

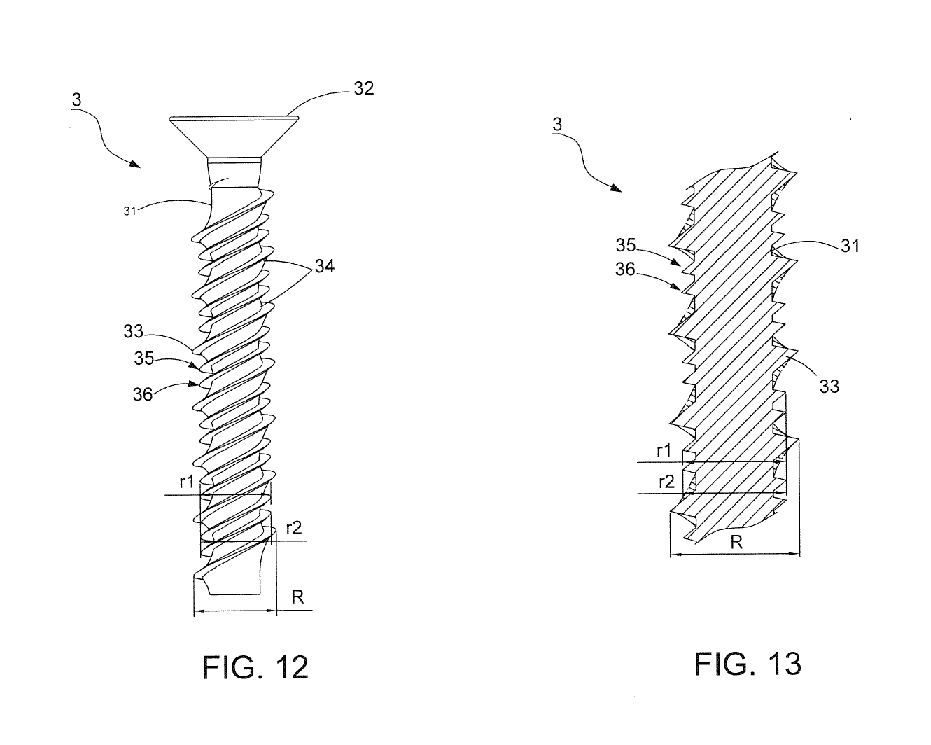

Referring to FIGS. 10-11, a fourth preferred embodiment of this invention still obtains the same effect as the previous embodiment. This embodiment is characterized in that at least one auxiliary thread 35 is disposed between any two adjacent main threads 33. A diameter r1 of the auxiliary thread 35 is smaller than a diameter R of each main thread 33. The auxiliary thread 35 comprises two auxiliary cutting faces 351, 352 connected with each other. This invention can also include two or more auxiliary threads. For example, FIGS. 12-13 show that two auxiliary threads 35, 36 are disposed between two adjacent main threads 33. The diameters r1, r2 of the auxiliary threads 35, 36 can be identical or different. Further, according to objects in different materials, the main thread 33 and the auxiliary threads 35, 36 can have variations in their thread shape, such as having asymmetric flank faces or a large thread pitch. Accordingly, the high-low arrangement constructed by threads 33 and auxiliary threads 35, 36 helps the fastener 3 reduce the drilling resistance and torque, thereby promoting the smoothness of the drilling action and attaining the firm screwing effect.

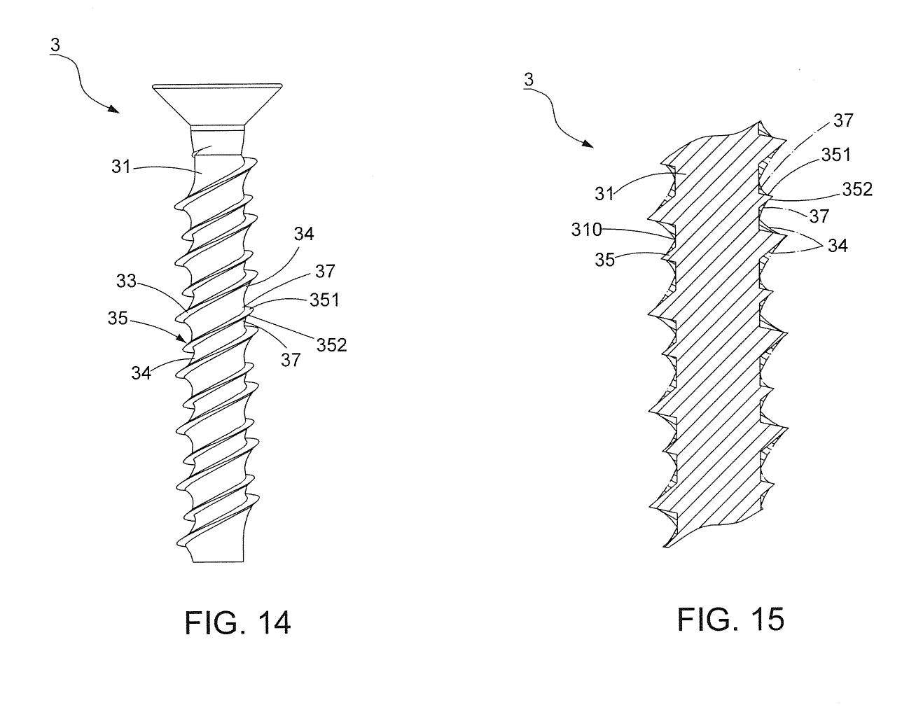

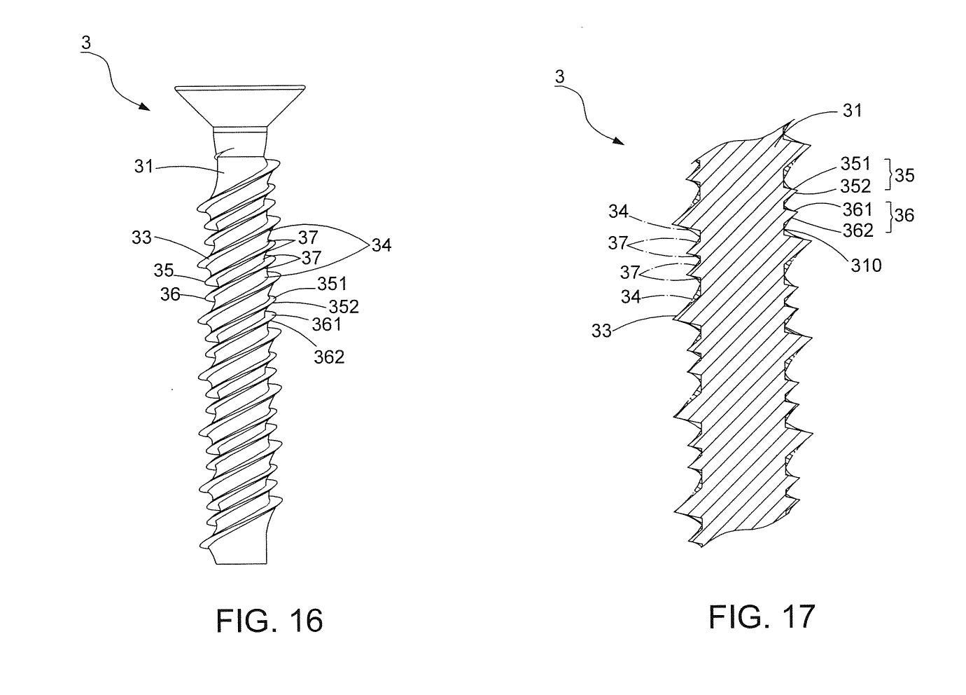

Referring to FIGS. 14-15, a sixth preferred embodiment of this invention comprises the same elements as the fourth embodiment. Particularly, this embodiment is to project at least one support lobe 37 from the shank 31. In other words, at least one support lobe 37 is extended outwards from the shank root 310 and attached to at least one auxiliary cutting face 351, 352 of the auxiliary thread 35. The support lobe 37 can be formed in a curved shape. This support lobe 37 is also applied to the structure of FIG. 12, and the combination is shown in FIGS. 16-17 by having the support lobes 37 extended outwards from the shank root 310 and attached to at least one or all auxiliary cutting faces 351, 352, 361, 362 of the auxiliary threads 35, 36. Therefore, the shank 31 with the main lobes 34 in cooperation with the support lobes 37 forms a multi-curved design projecting from the shank root 310 to obtain a stable support effect. This support effect allows the fastener 3 to be drilled into the object more firmly and stably and prevents the occurrence of the poor screwing effect due to the swinging action of the fastener 3 which incurs a reaming problem. Therefore, this invention increases the firm engagement of the fastener 3 with the object.

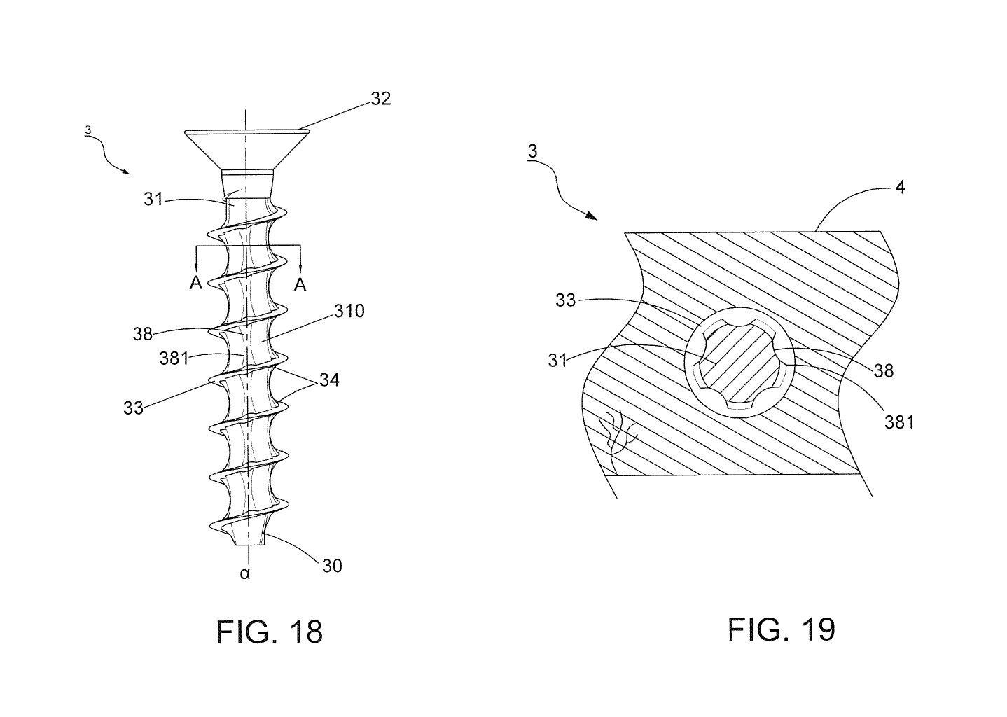

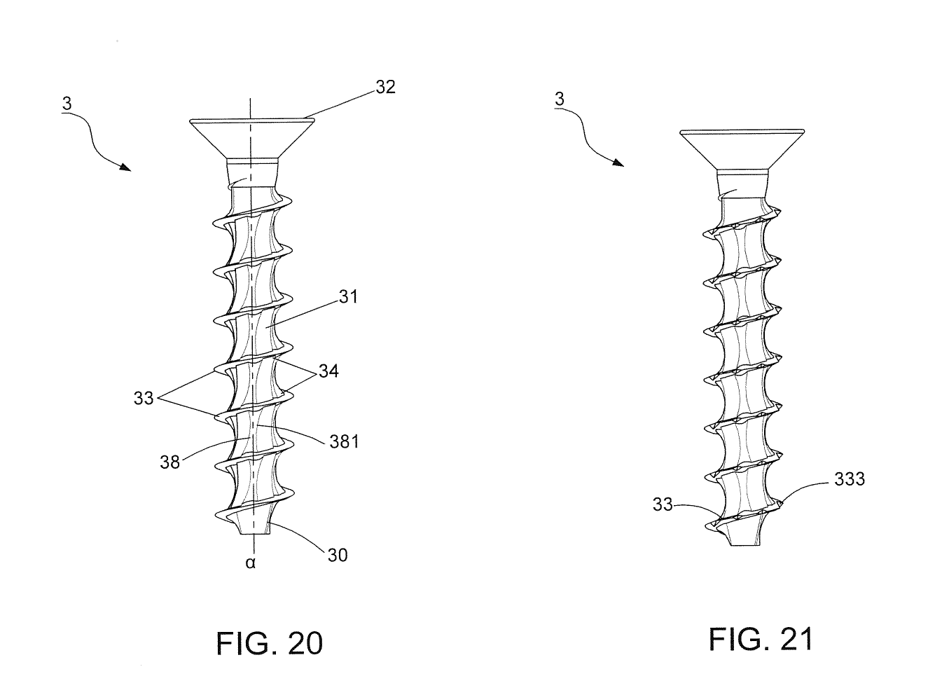

Referring to FIGS. 18-19, an eighth preferred embodiment of this invention still comprises a shank 31, a head 32, main threads 33, at least one main lobe 34 and a drilling portion 30. Particularly, this embodiment includes a plurality of slits 38 recessedly defined on the shank 31 and extended between two adjacent main threads 33. Each of the slits 38 is intersected with the shank root 310 of the shank 31 to form a cutting edge 381. The slit 38 can be parallel to or inclined to the shank axis α, shown in FIG. 18 and FIG. 20 respectively. While drilled in to the object, the fastener 3 takes advantage of the cutting edge 381 to increase the drilling speed. Some debris can be expelled by the slits 38 and the residual debris can be accommodated in the slits 38, thereby increasing the screwing effect, preventing the generation of the resonant vibratory effect owing to external vibrations and promoting the smoothness of the drilling operation.

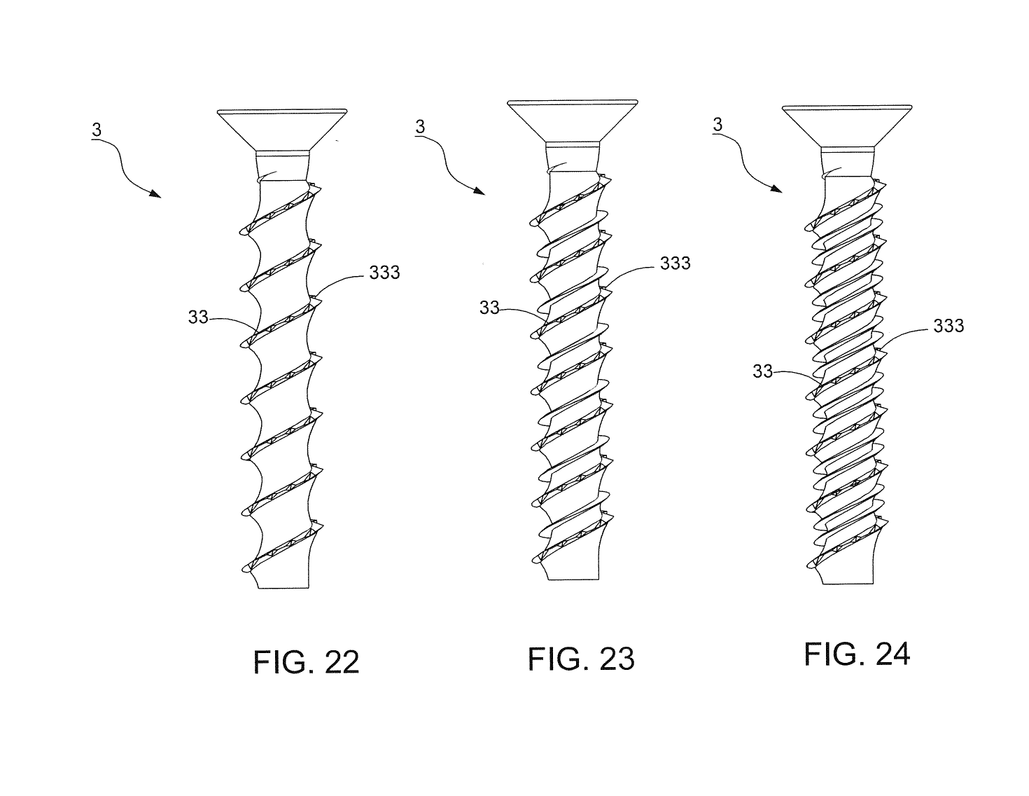

Referring to FIG. 21, a ninth preferred embodiment of this invention, comprising the same elements as the eighth embodiment, is characterized in that plural notches 333 are formed on each of the main threads 33. The notches 333 are also applied to different preferred embodiments presented supra. For example, FIGS. 22-24 show the notches 333 are incorporated into structures of FIG. 6, FIG. 14 and FIG. 16 respectively. By the main lobe 34 or the main lobe 34 in cooperation with the support lobe 37, the fastener 3 possesses the good torsion resistance and the tensile strength against the drilling stress to prevent itself from snapping. The notches 333 increase the cutting capability of the main threads 33 and facilitate the removal of the debris, thereby reducing the friction resistance and torque and increasing the screwing efficiency and screwing engagement.

The advantages of this invention are as follows:

1. Because the main thread 33 is inclined with respect to the shank axis α by 60-82 degrees, the main threads 33 are drilled into the object 4 with a proper rotating angle. Furthermore, the extension of the main lobe 34 from the shank root 310 to the main thread 33 gives the main threads 33 a support effect to resist the drilling stress and prevent the main threads 33 from breaking. The rotation resistance impinging on the main threads 33 is also decreased so that the main thread 33 cuts the object 4 sharply to increase the drilling speed.
2. When the fastener 3 is drilled into the object 4, the multi-curved arrangement constructed by the main lobe 34 and the support lobe 37 allows the threads 33, 35, 36 to attain the preferable torque and the flexibility and obtain the preferable torsion resistance and the tensile strength for bearing the increasing drilling stress. Therefore, this invention prevents the fastener 3 from twisting and snapping.
3. The shank 31 can define the slits 38 between two adjacent main threads 33 to accommodate some debris cut by the main threads 33 and can form the notches 333 to help the main threads 33 cut fibers whereby the fastener 3 is firmly screwed into the object 4. For the object 4 made from a material with plasticity, this invention prevents the fastener 3 from loosening easily and gives the fastener 3 the high force resisting the drilling stress in order to increase the tensile strength and prevent the fastener 3 from loosening because of the resonant vibratory effect caused by external vibrations.

To sum up, this invention comprises each main thread inclined with respect to a shank axis by 60-82 degrees to provide a larger rotating angle and facilitate a rapid drilling operation. This invention also comprises at least one main lobe projecting from the shank to be attached to at least one cutting face of each main thread so that the fastener has the higher force to resist the drilling stress. Therefore, this invention prevents the fastener from snapping and reduces the resonant vibratory effect to promote a firm fastening effect.

While the embodiments of this invention are shown and described, it is understood that further variations and modifications may be made without departing from the scope of this invention.

What is claimed is:

1. A fastener comprising:
a shank defining a shank root;
a head disposed on one end of said shank;
a drilling portion disposed on the other end of said shank; and
a plurality of main threads spirally disposed on said shank, each of said main threads comprising two inclined cutting faces connected with each other;
wherein each of said main threads is inclined with respect to a shank axis by 60-82 degrees, at least one main lobe projecting from said shank, said main lobe being extended outwards from said shank root and attached to at least one cutting face of each of said main threads.

2. The fastener as claimed in claim 1, wherein said main lobe is formed in a curved shape.

3. The fastener as claimed in claim 1, wherein at least one auxiliary thread is disposed between any two adjacent main threads, a diameter of said auxiliary thread being smaller than a diameter of each main thread.

4. The fastener as claimed in claim 2, wherein at least one auxiliary thread is disposed between any two adjacent main threads, a diameter of said auxiliary thread being smaller than a diameter of each main thread.

5. The fastener as claimed in claim 3, wherein said auxiliary thread comprises two auxiliary cutting faces connected with each other, at least one support lobe projecting from said shank, said support lobe being extended outwards from said shank root and attached to at least one auxiliary cutting face of said auxiliary thread.

6. The fastener as claimed in claim 4, wherein said auxiliary thread comprises two auxiliary cutting faces connected with each other, at least one support lobe projecting from said shank, said support lobe being extended outwards from said shank root and attached to at least one auxiliary cutting face of said auxiliary thread.

7. The fastener as claimed in claim 1, wherein said shank has a plurality of slits recessedly defined thereon, each of said slits extending between two adjacent main threads, each of said slits being intersected with said shank root of said shank to form a cutting edge.

8. The fastener as claimed in claim 1, wherein said drilling porting has a helical section coming to a sharp leading point.

9. The fastener as claimed in claim 1, wherein each of said main threads comprises a plurality of notches formed thereon.
